(19) United States
(12) Patent Application Publication
(10) Pub. No.: US 2011/0271008 A1
(43) Pub. Date: Nov. 3, 2011

(54) Selective TCP Large Receive Aggregation Based On IP Destination Address

(75) Inventors: Jiandi An, Austin, TX (US); Omar Cardona, Cedar Park, TX (US); James B. Cunningham, Austin, TX (US); Matthew Ochs, Austin, TX (US)

(73) Assignee: International Business Machines Corporation, Armonk, NY (US)

(21) Appl. No.: 12/770,127

(22) Filed: Apr. 29, 2010

(51) Int. Cl. G06F 15/16

(52) U.S. Cl. 709/242; 709/238

(57) ABSTRACT

An information handling device receives a packet and determines a packet destination for the packet. In turn, the information handling device either aggregates the packet in response to determining that the packet destination is a local destination, or forwards the packet in response to determining that the packet destination is a non-local destination.

### TECHNICAL FIELD

The present disclosure relates to selectively aggregating packets based upon a packet's target destination.

### BACKGROUND

Computer systems today receive “packets” from other computer systems over a computer network, such as the Internet. These packets typically include header information that identifies the packet's target destination. Common headers are Internet Protocol (IP) headers and Transmission Control Protocol (TCP) headers, which identify a destination host computer along with a target application executing on the host computer to which a corresponding packet belongs. In some cases, a computer system may enable IP forwarding, which allows the computer system to receive and forward packets to the destination host computer.

### SUMMARY

An information handling device receives a packet and determines a packet destination for the packet. In turn, the information handling device either aggregates the packet in response to determining that the packet destination is a local destination, or forwards the packet in response to determining that the packet destination is a non-local destination.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present disclosure, as defined solely by the claims, will become apparent in the non-limiting detailed description set forth below.

### BRIEF DESCRIPTION OF THE DRAWINGS

The present disclosure may be better understood, and its numerous objects, features, and advantages made apparent to those skilled in the art by referencing the accompanying drawings, wherein:

FIG. 1 is a diagram showing an information handling device processing packets according to whether the packets are targeted for a local destination address or a non-local destination address;

FIG. 2 is a diagram showing an information handling device that includes a packet analyzer included in a network interface card for processing packets according to whether the packets are targeted for a local destination address or a non-local destination address;

FIG. 3 is a diagram showing an embodiment of aggregating local packets based upon TCP header context information;

FIG. 4 is a flowchart showing an example of steps taken in processing a packet according to the packet's target destination;

FIG. 5 is a flowchart showing an example of steps taken in aggregating local packets;

FIG. 6 is a block diagram example of a data processing system in which the methods described herein can be implemented; and

FIG. 7 provides an extension example of the information handling device environment shown in FIG. 6 to illustrate that the methods described herein can be performed on a wide variety of information handling devices which operate in a networked environment.

### DETAILED DESCRIPTION

Certain specific details are set forth in the following description and figures to provide a thorough understanding of various embodiments of the disclosure. Certain well-known details often associated with computing and software technology are not set forth in the following disclosure, however, to avoid unnecessarily obscuring the various embodiments of the disclosure. Further, those of ordinary skill in the relevant art will understand that they can practice other embodiments of the disclosure without one or more of the details described below. Finally, while various methods are described with reference to steps and sequences in the following disclosure, the description as such is for providing a clear implementation of embodiments of the disclosure, and the steps and sequences of steps should not be taken as required to practice this disclosure. Instead, the following is intended to provide a detailed description of an example of the disclosure and should not be taken to be limiting of the disclosure itself. Rather, any number of variations may fall within the scope of the disclosure, which is defined by the claims that follow the description.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The following detailed description will generally follow the summary of the disclosure, as set forth above, further explaining and expanding the definitions of the various aspects and embodiments of the disclosure as necessary.

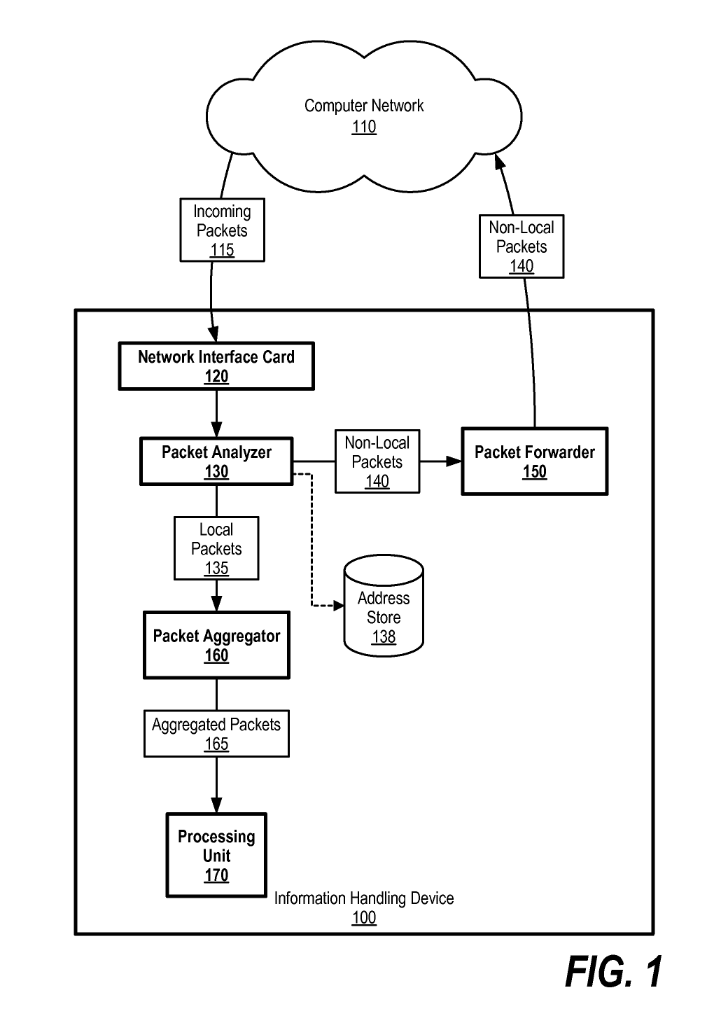

FIG. 1 is a diagram showing an information handling device processing packets according to whether the packets are targeted for a local destination address or a non-local destination address. Information handling device 100 (e.g., desktop computer, server, router, notebook, netbook, etc.) receives incoming packets 115 from computer network 110, such as the Internet. Each of incoming packets 115 includes an Internet Protocol (IP) header and a Transmission Control Protocol (TCP) header. Each IP header includes a destination IP address, which identifies the corresponding packet's indented host destination (e.g., computer XYZ).

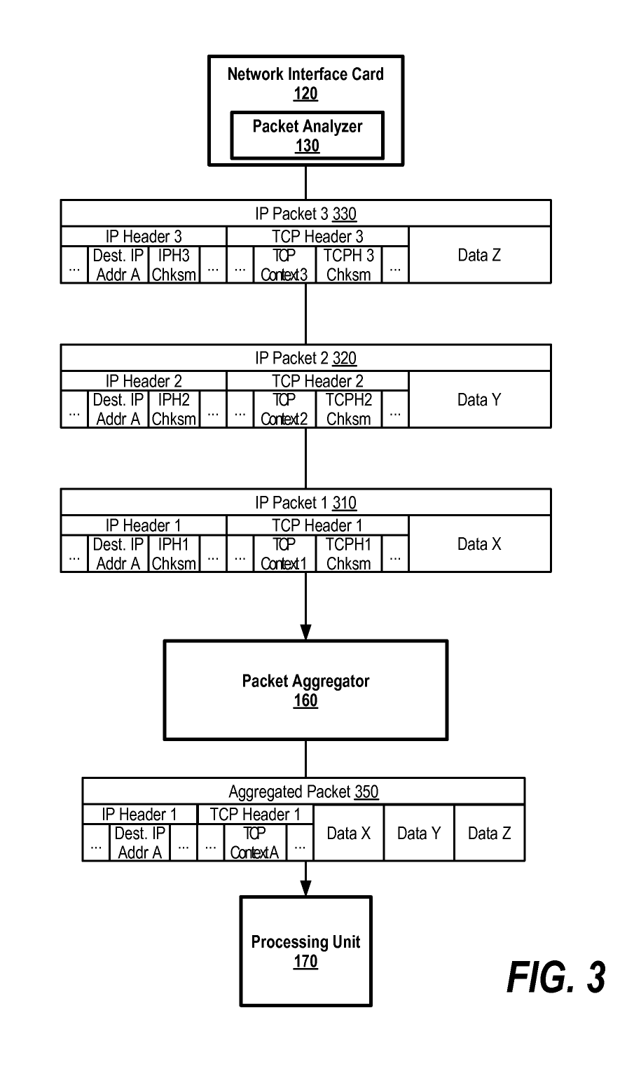

Each TCP header includes TCP connection context that includes, for example, a source port identifier, a destination port identifier, and a sequence number. The TCP destination port identifies which application within the host destination computer the corresponding packet belongs (see FIG. 3 and corresponding text for further details).

Network interface card 120 receives incoming packets 115 and analyzes their IP headers to determine whether information handling device 100 is the intended destination or, when IP forwarding is enabled on information handling device 100, whether information handling device 100 should receive the corresponding packet and forward the packet to its intended destination.

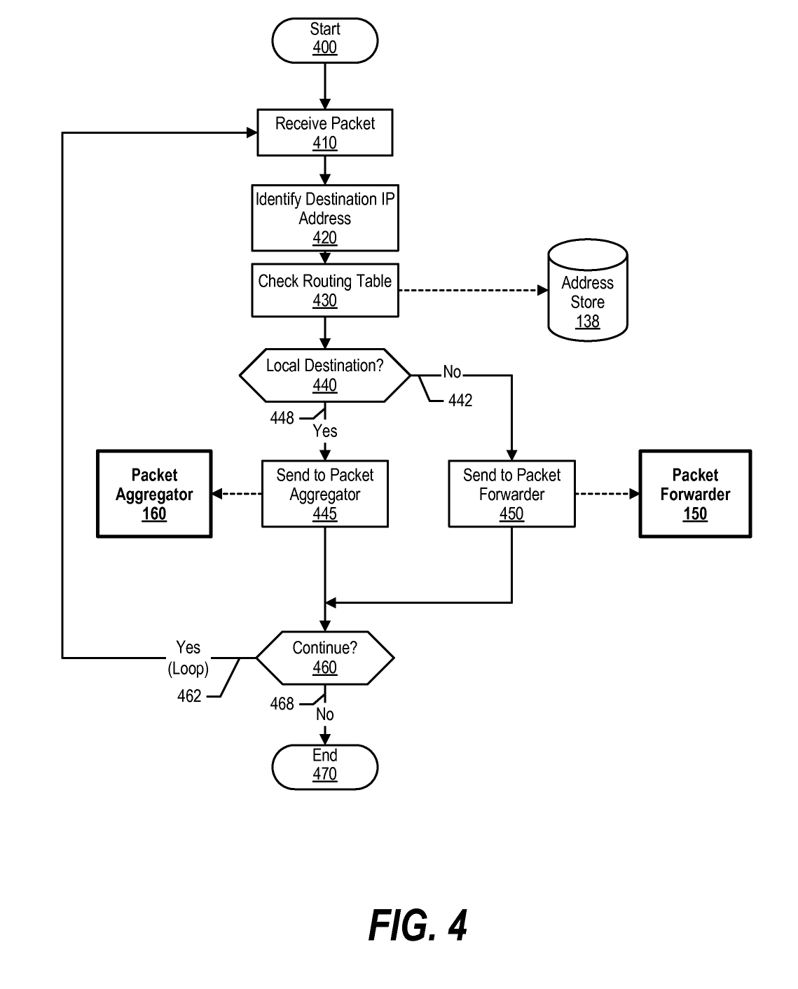

Packet analyzer 130 receives packets from network interface card 120, some of which are local packets (local destination) and others of which are non-local packets (non-local, forwarding packets). Packet analyzer 130 analyzes the IP headers in the received packets and, based upon a routing table in address store 130, packet analyzer 130 determines whether each packet is a local packet or a non-local packet (see FIG. 4 and corresponding text for further details). In turn, packet analyzer 130 sends local packets 135 to packet aggregator 160 for aggregation, and sends non-local packets 140 to packet forwarder 150 in order for packet forwarder 150 to forward the non-local packets to their intended destinations through computer network 110. In one embodiment, packet analyzer 130 may send both local packets 135 and non-local packets 140 to information handling device 100's IP stack for further processing. In this embodiment, information handling device 100 then processes each packet from the IP stack accordingly (aggregating local packets and forwarding non-local packets).

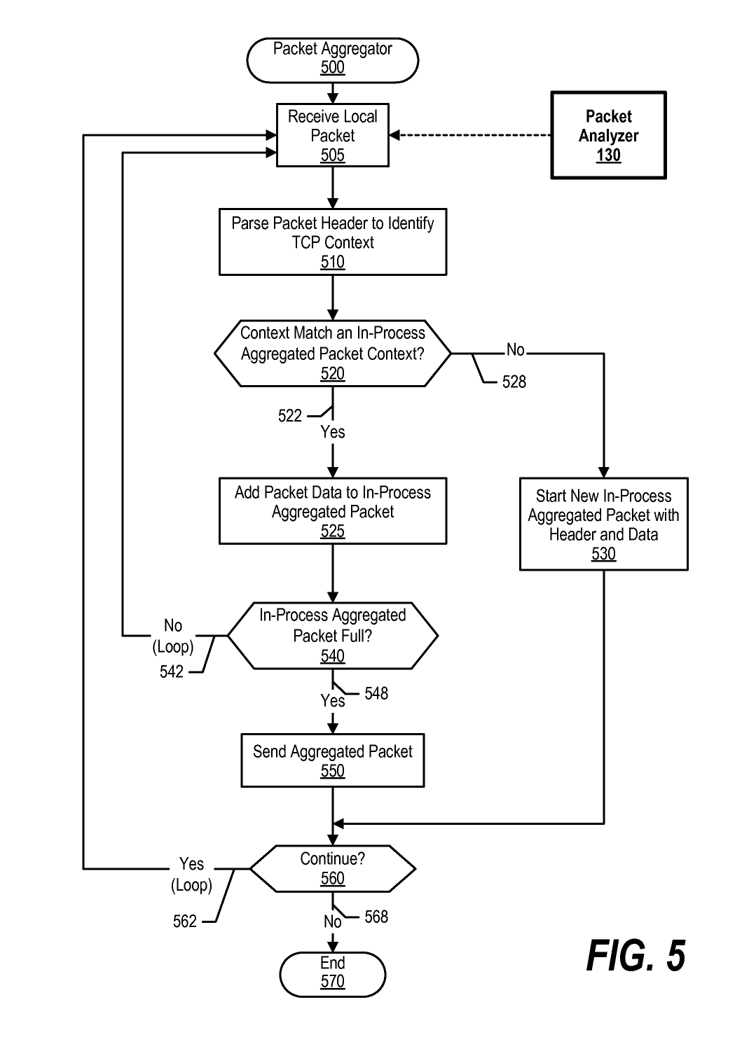

Packet aggregator 160 receives local packets 135 and aggregates local packets 135 into aggregated packets 165 according to their corresponding TCP headers' context (see FIGS. 3, 5, and corresponding text for further details). Processing unit 170 processes aggregated packets accordingly, such as sending packet data included in one of aggregated packets 165 to a corresponding application.

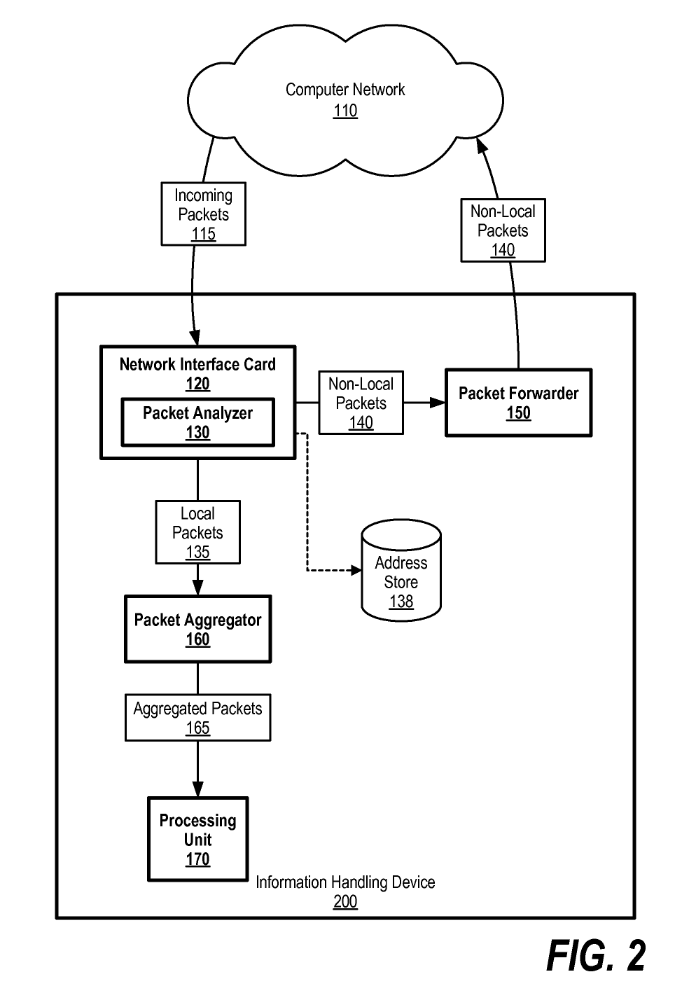

FIG. 2 is a diagram showing an information handling device that includes a packet analyzer included in a network interface card for processing packets according to whether the packets are targeted for a local destination address or a non-local destination address. FIG. 2 is similar to FIG. 1 with the exception that network interface card 120 includes packet analyzer 130. For example, packet analyzer 130 may be a software subroutine/firmware included in network interface card 120, and/or may be a combination of hardware and software to perform functions of packet analyzer 130 described in this disclosure.

FIG. 3 is a diagram showing an embodiment of aggregating local packets based upon TCP header context information. FIG. 3 shows an embodiment when network interface card 120 includes packet analyzer 130, such as that shown in FIG. 2. As those skilled in the art can appreciate, the process of aggregating local packets using a configuration embodiment shown in FIG. 1 is similar to that shown in FIG. 3.

Each of packets 310-330 includes a destination IP address, an IP checksum, TCP context, and a TCP checksum. Packet analyzer 130 analyzes destination IP addresses included in packets 310-330 to determine whether the packets correspond to a local destination (local destination IP address) or a non-local destination (non-local destination IP address). The example shown in FIG. 3 shows that each of packets 310-330 have a local destination IP address (destination IP address A). As such, packet analyzer 130 sends each of packets 310-330 to packet aggregator 160.

Packet aggregator 160 analyzes the TCP context included in packets 310-330, which includes analyzing each of packets 310-330 source port identifier, destination port identifier, and sequence number. In one embodiment, in order for packet aggregator 160 to aggregate local packet data into an large receive aggregated packet, the local packets have the same source port identifier (came from the same source); have the same destination port identifier (targeted for the same destination), and have a sequence number that is in order (e.g., sequence 1, 2, 3, etc.).

The example shown in FIG. 3 shows that, packet aggregator 160 determined that packets 310-330 should be aggregated and, therefore, creates aggregated packet 350. Aggregated packet 350 includes the same destination IP address A as packets 310-330, along with data X, data Y, and data Z from packets 310-330. Aggregated packet 350 also includes TCP context A, which includes the same source port identifier and destination port identifier as packets 310-330, and also includes the sequence number corresponding to packet 310. For example, assuming the sequence number of packet 310 is “1” and it's data payload length is 100 bytes, then the TCP sequence number of packet 320 will be 101 (1+100 bytes). Continuing with this example, the resulting aggregated packet 350 that is built from packets 310, 320, and 330, include a sequence number of “1” (the sequence number of the first TCP packet 310). Note that aggregated packet 350 does not include a valid IP checksum value or a valid TCP checksum value. In one embodiment, when one of packets 310-330 include a different destination port identifier, packet aggregator 160 creates a different aggregated packet and aggregates subsequent packets that include the different destination port identifier (see FIG. 5 and corresponding text for further details).

FIG. 4 is a flowchart showing an example of steps taken in processing a packet according to the packet's target destination. In one embodiment, a packet analyzer, such as packet analyzer 130 shown in FIGS. 1 and 2, performs one or more of the steps shown in FIG. 4. Processing commences at 400, whereupon processing receives a packet at step 410, such as from a network interface card. At step 420, processing identifies a destination IP (Internet Protocol) address. The destination IP address is included in the received packet's IP header (see FIG. 3 and corresponding text for further details).

Next, processing checks the packet's destination IP address against a routing table included in address store 138. The routing table identifies local destination IP addresses and non-local destination IP addresses. The local destination IP addresses are those IP addresses that are processed by the local host, while the non-local destination IP addresses are those IP addresses targeted for other hosts to which the local host is enabled to forward.

A determination is made as to whether the received packet is targeted for a local destination or a non-local destination (decision 440). If the received packet is targeted for a non-local destination (non-local packet), decision 440 branches to “No” branch 442 whereupon processing sends the non-local packet to packet forwarder 150 to forward accordingly (step 450). On the other hand, if the received packet is targeted for a local destination (local packet), decision 440 branches to “Yes” branch 448 whereupon processing sends the local packet to packet aggregator 160 for further processing (see FIG. 5 and corresponding text for further details).

In one embodiment, processing may send both local packets and non-local packets to an information handling device's IP stack for further processing. In this embodiment, the information handling device then processes each packet from the IP stack accordingly (aggregating local packets and forwarding non-local packets).

A determination is made as to whether to continue to process packets (decision 460). If processing should continue, decision 460 branches to “Yes” branch 462, which loops back to receive and process another packet. This looping continues until processing should terminate, at which point decision 460 branches to “No” branch 468 whereupon processing ends at 470.

FIG. 5 is a flowchart showing an example of steps taken in aggregating local packets. In one embodiment, packet aggregator 160 (shown in FIGS. 1 and 2) performs one or more of the steps shown in FIG. 5. Processing commences at 500, whereupon processing receives a local packet from packet analyzer 130 (step 505). Packet analyzer 130 separates packets with a local destination IP address and sends them to the packet aggregator for aggregation, such as for a Large Receive (LR) aggregation.

At step 510, processing parses the local packet's header to identify the packet's TCP context. The TCP context may include the packet's source port, destination port, and sequence number. The source port identifies a sending port of the packet. The destination port identifies a receiving port of the packet. And, the sequence number identifies a location of the packet within a stream of packets (e.g., packet 14).

A determination is made as to whether the TCP context matches an in-process aggregated packet (decision 520). For example, an in-process aggregated packet may include source port X, destination port Y, and include packets up to sequence number 11. In this example, processing determines whether the received packet's TCP connection context includes source port X, destination port Y, and sequence number 12.

If the received packet's TCP context does not match an in-process aggregated packet context, decision 520 branches to “No” branch 528 whereupon processing starts a new in-process aggregated packet with a new header and the data included in the received packet (step 530). Using the example above, in one embodiment, processing may receive a packet with TCP context of source port X, destination port Y, and sequence number 13 (out of order packet). In this embodiment, processing may start a new in-process aggregated packet starting with sequence number 13′s data.

On the other hand, if the received packet's TCP context matches an in-process aggregated packet context, decision 520 branches to “Yes” branch 522, whereupon processing adds the data included in the packet to the in-process aggregated packet at step 525 (see FIG. 3 and corresponding text for further details). A determination is made as to whether the in-process aggregated packet is full (e.g., all data slots are full) (decision 540). If the in-process aggregated packet is not full, decision 540 branches to “No” branch 542, which loops back to process another packet. This looping continues until one of the in-process aggregated packets are full, at which point decision 540 branches to “Yes” branch 548 whereupon processing sends the full aggregated packet for further processing at step 550 (e.g., to processing unit 170 shown in FIGS. 1 and 2).

A determination is made as to whether to continue aggregating packets (decision 560). If processing should continue, decision 560 branches to “Yes” branch 562, which loops back to continue processing local packets. This looping continues until processing should terminate, at which point decision 560 branches to “No” branch 568 whereupon processing ends at 570.

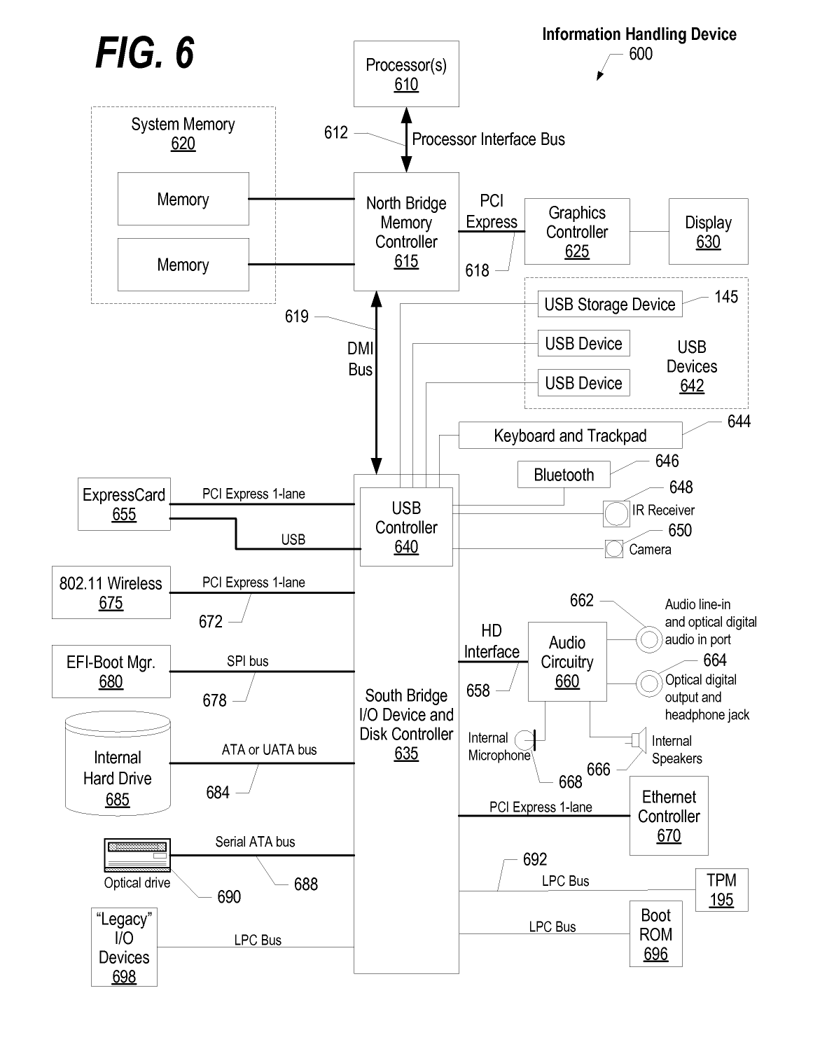

FIG. 6 illustrates information handling device 600, which is a simplified example of a computer system capable of performing the computing operations described herein, such as information handling device 100 shown in FIGS. 1 and 2. Information handling device 600 includes one or more processors 610 coupled to processor interface bus 612. Processor interface bus 612 connects processors 610 to Northbridge 615, which is also known as the Memory Controller Hub (MCH). Northbridge 615 connects to system memory 620 and provides a means for processor(s) 610 to access the system memory. Graphics controller 625 also connects to Northbridge 615. In one embodiment, PCI Express bus 618 connects Northbridge 615 to graphics controller 625. Graphics controller 625 connects to display device 630, such as a computer monitor.

Northbridge 615 and Southbridge 635 connect to each other using bus 619. In one embodiment, the bus is a Direct Media Interface (DMI) bus that transfers data at high speeds in each direction between Northbridge 615 and Southbridge 635. In another embodiment, a Peripheral Component Interconnect (PCI) bus connects the Northbridge and the Southbridge. Southbridge 635, also known as the I/O Controller Hub (ICH) is a chip that generally implements capabilities that operate at slower speeds than the capabilities provided by the Northbridge. Southbridge 635 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 696 and “legacy” I/O devices (using a “super I/O” chip). The “legacy” I/O devices (698) can include, for example, serial and parallel ports, keyboard, mouse, and/or a floppy disk controller. The LPC bus also connects Southbridge 635 to Trusted Platform Module (TPM) 695. Other components often included in Southbridge 635 include a Direct Memory Access (DMA) controller, a Programmable Interrupt Controller (PIC), and a storage device controller, which connects Southbridge 635 to nonvolatile storage device 685, such as a hard disk drive, using bus 684.

ExpressCard 655 is a slot that connects hot-pluggable devices to the information handling device. ExpressCard 655 supports both PCI Express and USB connectivity as it connects to Southbridge 635 using both the Universal Serial Bus (USB) the PCI Express bus. Southbridge 635 includes USB Controller 640 that provides USB connectivity to devices that connect to the USB. These devices include webcam (camera) 650, infrared (IR) receiver 648, keyboard and trackpad 644, and Bluetooth device 646, which provides for wireless personal area networks (PANs). USB Controller 640 also provides USB connectivity to other miscellaneous USB connected devices 642, such as a mouse, removable nonvolatile storage device 645, modems, network cards, ISDN connectors, fax, printers, USB hubs, and many other types of USB connected devices. While removable nonvolatile storage device 645 is shown as a USB-connected device, removable nonvolatile storage device 645 could be connected using a different interface, such as a Firewire interface, etcetera.

Wireless Local Area Network (LAN) device 675 connects to Southbridge 635 via the PCI or PCI Express bus 672. LAN device 675 typically implements one of the IEEE 802.11 standards of over-the-air modulation techniques that all use the same protocol to wirelessly communicate between information handling device 600 and another computer system or device. Optical storage device 690 connects to Southbridge 635 using Serial ATA (SATA) bus 688. Serial ATA adapters and devices communicate over a high-speed serial link. The Serial ATA bus also connects Southbridge 635 to other forms of storage devices, such as hard disk drives. Audio circuitry 660, such as a sound card, connects to Southbridge 635 via bus 658. Audio circuitry 660 also provides functionality such as audio line-in and optical digital audio in port 662, optical digital output and headphone jack 664, internal speakers 666, and internal microphone 668. Ethernet controller 670 connects to Southbridge 635 using a bus, such as the PCI or PCI Express bus. Ethernet controller 670 connects information handling device 600 to a computer network, such as a Local Area Network (LAN), the Internet, and other public and private computer networks.

While FIG. 6 shows one information handling device, an information handling device may take many forms. For example, an information handling device may take the form of a desktop, server, portable, laptop, notebook, or other form factor computer or data processing system. In addition, an information handling device may take other form factors such as a personal digital assistant (PDA), a gaming device, ATM machine, a portable telephone device, a communication device or other devices that include a processor and memory.

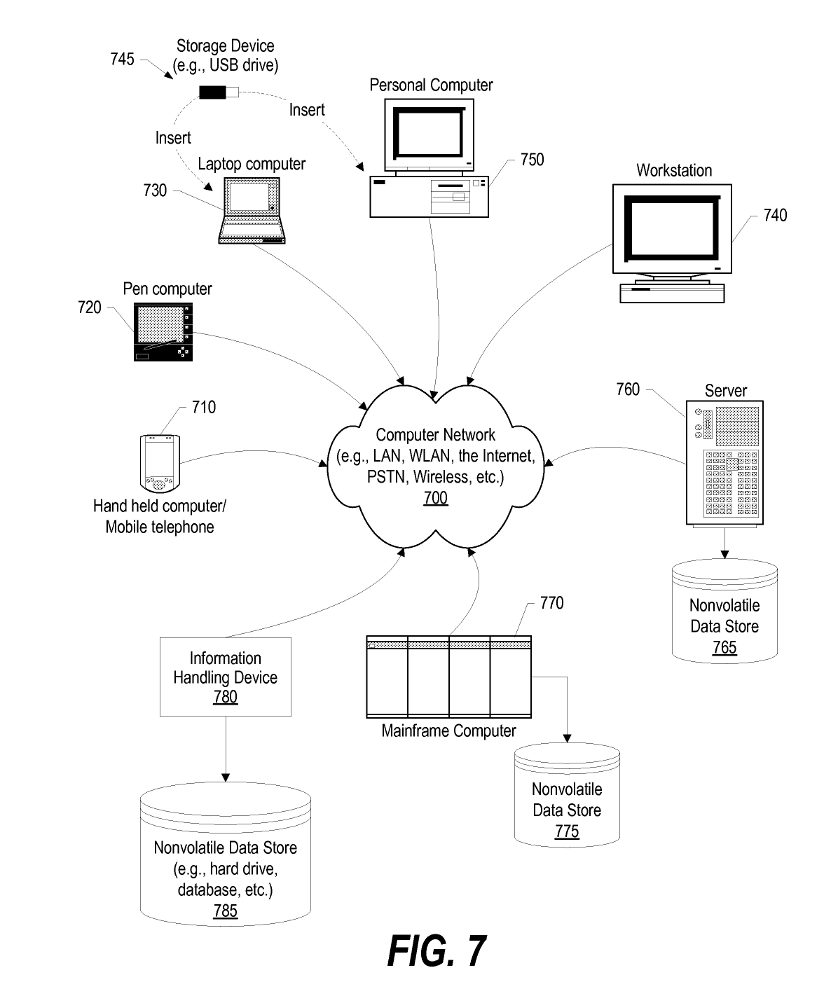

The Trusted Platform Module (TPM 695) shown in FIG. 6 and described herein to provide security functions is but one example of a hardware security module (HSM). Therefore, the TPM described and claimed herein includes any type of HSM including, but not limited to, hardware security devices that conform to the Trusted Computing Groups (TCG) standard, and entitled “Trusted Platform Module (TPM) Specification Version 1.2.” The TPM is a hardware security subsystem that may be incorporated into any number of information handling devices, such as those outlined in FIG. 7.

FIG. 7 provides an extension example of the information handling device environment shown in FIG. 6 to illustrate that the methods described herein can be performed on a wide variety of information handling devices that operate in a networked environment. Types of information handling devices range from small handheld devices, such as handheld computer/mobile telephone 710 to large mainframe systems, such as mainframe computer 770. Examples of handheld computer 710 include personal digital assistants (PDAs), personal entertainment devices, such as MP3 players, portable televisions, and compact disc players. Other examples of information handling devices include pen, or tablet, computer 720, laptop, or notebook, computer 730, workstation 740, personal computer system 750, and server 760. Other types of information handling devices that are not individually shown in FIG. 7 are represented by information handling device 780. As shown, the various information handling devices can be networked together using computer network 700. Types of computer network that can be used to interconnect the various information handling devices include Local Area Networks (LANs), Wireless Local Area Networks (WLANs), the Internet, the Public Switched Telephone Network (PSTN), other wireless networks, and any other network topology that can be used to interconnect the information handling devices. Many of the information handling devices include nonvolatile data stores, such as hard drives and/or nonvolatile memory. Some of the information handling devices shown in FIG. 7 depicts separate nonvolatile data stores (server 760 utilizes nonvolatile data store 765, mainframe computer 770 utilizes nonvolatile data store 775, and information handling device 780 utilizes nonvolatile data store 785). The nonvolatile data store can be a component that is external to the various information handling devices or can be internal to one of the information handling devices. In addition, removable nonvolatile storage device 745 can be shared among two or more information handling devices using various techniques, such as connecting the removable nonvolatile storage device 745 to a USB port or other connector of the information handling devices.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While particular embodiments of the present disclosure have been shown and described, it will be obvious to those skilled in the art that, based upon the teachings herein, that changes and modifications may be made without departing from this disclosure and its broader aspects. Therefore, the appended claims are to encompass within their scope all such changes and modifications as are within the true spirit and scope of this disclosure. Furthermore, it is to be understood that the disclosure is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to disclosures containing only one such element, even when the same claim includes the introductory phrases “one or more” or “at least one” and indefinite articles such as “a” or “an”; the same holds true for the use in the claims of definite articles.

What is claimed is:

1. A machine-implemented method comprising:
receiving a packet at an information handling device;
determining a packet destination for the packet;
aggregating the packet in response to determining that the packet destination is a local destination; and
forwarding the packet in response to determining that the packet destination is a non-local destination.

2. The method of claim 1 wherein the packet includes one or more checksums, and wherein:
the aggregating removes at least one of the checksums from the packet; and
the forwarding maintains each of the one or more checksums in the packet.

3. The method of claim 1 further comprising:
enabling Internet protocol forwarding at the information handling device; and
receiving non-local destination packets at the information handling device in response to the information handling device enabling Internet protocol forwarding.

4. The method of claim 1 wherein the aggregating corresponds to an Ethernet large receive process, the method further comprising:
identifying an in-process aggregated large packet that includes a large receive header and one or more data fields; and
adding data included in the received packet to the one or more data fields.

5. The method of claim 4 wherein the aggregating further comprises:
parsing a packet header included in the received packet to identify a Transmission Control Protocol context;
determining whether the Transmission Control Protocol context matches an in-process aggregation packet context corresponding to the aggregated large packet; and
adding the data to the one or more data fields in response to determining that the Transmission Control Protocol context matches the in-process aggregation packet context.

6. The method of claim 5 wherein the Transmission Control Protocol context includes a source port, a destination port, and a sequence number.

7. The method of claim 1 wherein the determining further comprises:
identifying a destination Internet Protocol address included in the received packet; and
comparing the destination Internet Protocol address with one or more routing table entries.

8. A computer program product stored in a computer readable medium, comprising functional descriptive material that, when executed by an information handling system, causes the information handling system to perform actions that include:
receiving a packet at the information handling device;
determining a packet destination for the packet;
aggregating the packet in response to determining that the packet destination is a local destination; and
forwarding the packet in response to determining that the packet destination is a non-local destination.

9. The computer program product of claim 8 wherein the packet includes one or more checksums, and wherein:
the aggregating removes at least one of the checksums from the packet; and
the forwarding maintains each of the one or more checksums in the packet.

10. The computer program product of claim 8 wherein the functional descriptive material that, when executed by the information handling system, causes the information handling system to further perform actions that include:
enabling Internet protocol forwarding at the information handling device; and
receiving non-local destination packets at the information handling device in response to the information handling device enabling Internet protocol forwarding.

11. The computer program product of claim 8 wherein the aggregating corresponds to an Ethernet large receive process, and wherein the functional descriptive material that, when executed by the information handling system, causes the information handling system to further perform actions that include:
identifying an in-process aggregated large packet that includes a large receive header and one or more data fields; and
adding data included in the received packet to the one or more data fields.

12. The computer program product of claim 11 wherein the functional descriptive material that, when executed by the information handling system, causes the information handling system to further perform actions that include:
parsing a packet header included in the received packet to identify a Transmission Control Protocol context;
determining whether the Transmission Control Protocol context matches an in-process aggregation packet context corresponding to the aggregated large packet; and
adding the data to the one or more data fields in response to determining that the Transmission Control Protocol context matches the in-process aggregation packet context.

13. The computer program product of claim 12 wherein the Transmission Control Protocol context includes a source port, a destination port, and a sequence number.

14. The computer program product of claim 8 wherein the functional descriptive material that, when executed by the information handling system, causes the information handling system to further perform actions that include:
identifying a destination Internet Protocol address included in the received packet; and
comparing the destination Internet Protocol address with one or more routing table entries.

15. An information handling system comprising:
one or more processors;
a memory accessible by at least one of the processors;
a set of instructions stored in the memory and executed by at least one of the processors in order to perform actions of:
receiving a packet at the information handling device;
determining a packet destination for the packet;
aggregating the packet in response to determining that the packet destination is a local destination; and
forwarding the packet in response to determining that the packet destination is a non-local destination.

16. The information handling system of claim 15 wherein the packet includes one or more checksums, and wherein:
the aggregating removes at least one of the checksums from the packet; and
the forwarding maintains each of the one or more checksums in the packet.

17. The information handling system of claim 15 wherein the set of instructions, when executed by one of the processors, further performs actions of:
enabling Internet protocol forwarding at the information handling device; and
receiving non-local destination packets at the information handling device in response to the information handling device enabling Internet protocol forwarding.

18. The information handling system of claim 15 wherein the aggregating corresponds to an Ethernet large receive process, and wherein the set of instructions, when executed by one of the processors, further performs actions of:
identifying an in-process aggregated large packet that includes a large receive header and one or more data fields; and
adding data included in the received packet to the one or more data fields.

19. The information handling system of claim 18 wherein the set of instructions, when executed by one of the processors, further performs actions of:
parsing a packet header included in the received packet to identify a Transmission Control Protocol context;
determining whether the Transmission Control Protocol context matches an in-process aggregation packet context corresponding to the aggregated large packet; and
adding the data to the one or more data fields in response to determining that the Transmission Control Protocol context matches the in-process aggregation packet context.

20. The information handling system of claim 19 wherein the Transmission Control Protocol context includes a source port, a destination port, and a sequence number.
